(19) United States
(12) Patent Application Publication
(10) Pub. No.: US 2002/0111203 A1
(43) Pub. Date: Aug. 15, 2002

(54) Sound-emitting jigsaw puzzle

(76) Inventor: Jimmy Chi, Taipei (TW)

Correspondence Address: PRO-TECHTOR INTERNATIONAL SERVICES, 20775 Norada Court, Saratoga, CA, 95070-3018, US

(21) Appl. No.: 09/782,924

(22) Filed: Feb. 13, 2001

(51) Int. Cl. A63F 9/24; G06F 19/00

(52) U.S. Cl. 463/9; 273/153 R

(57) ABSTRACT

A sound-emitting jigsaw puzzle includes a base on which a control unit is mounted to receive signals from a key unit and to emit a specific sound via a speaker according to the signals from the key unit. The key unit includes a face panel, below which an upper and a lower circuit-contained film sandwiching an isolating film between them are provided. A plurality of equally spaced contacts are provided on the upper and the lower films to form a dot matrix when the two films are fully overlapped with each other. The isolating film is provided with a plurality of through holes corresponding to contacts on the upper and the lower films. The face panel is made of a high durometer foam rubber and has a lower surface provided with a plurality of keys corresponding to the contacts. When any area of the face panel is depressed, a key below the area is moved downward to cause corresponding contacts on the upper and the lower films to electrically contact with one another via the through hole on the isolating film and a specific sound is emitted. The sound-emitting jigsaw puzzle has low profile and may have increased number of contacts by reducing the interval between the contacts.

### BACKGROUND OF THE INVENTION

The present invention relates to a sound-emitting jigsaw puzzle, and more particularly to a sound-emitting jigsaw puzzle having improved key structure that allows reduced overall thickness of the puzzle as well as reduced interval between contacts and therefore increased number of contacts in the circuit of the puzzle for emitting sounds, making the puzzle more interesting for play.

The jigsaw puzzle is a traditional intellectual game that brings a lot of funs and joys to many people. It usually includes a framed board and a plurality of irregularly shaped pieces that are to be put together on the framed board to make a complete picture, etc. In recent years, highly developed electronic technology has been included in jigsaw puzzles to make it more interesting. A sound-emitting jigsaw puzzle is an example of these improved jigsaw puzzles. Taiwan Patent laid open under No. 166939 discloses a sound-emitting jigsaw puzzle having a base, a face panel, and a plurality of irregularly shaped puzzle pieces to be put together on the face panel. The base is provided at one end with a circuit board having a sound emitting means integrated therein. The base is also provided with contacts that protrude from the face panel. When a piece of the jigsaw puzzle is laid on the face panel and therefore depresses a contact, a contacting plate connected to the contact is lowered to contact with an interconnecting plate located at one side of the contact. The base is also provided at a corner with multiple select keys, each of which has an upper end projected from the face panel and a lower end loaded with a spring. When a piece of the puzzle is laid on one of the select keys, the key is elastically lowered to electrically contact with the circuit board for the latter to emit sound.

The above-described sound-emitting jigsaw puzzle has the following drawbacks:

1. It has complicate key structure that requires a lot of time to assemble, resulting in increased labor cost and decreased productivity.

2. It includes a large number of different components to complete the key structure and therefore has a large volume. On the other hand, only limited number of keys could be mounted in the base that has a fixed area.

3. It has fixed area and can be provided with limited number of keys, accordingly.

4. It requires increased manufacturing cost due to the large number of components included in the key structure and is therefore not economical for use and not competitive in the market.

It is therefore tried by the inventor to develop an improved sound-emitting jigsaw puzzle to eliminate the above-mentioned drawbacks by disposing on a base a face panel, and upper and lower circuit-contained films to sandwich an isolating film between them, so that a low-profile key structure in the form of a dot matrix is provided. The low-profile key structure enables the sound-emitting jigsaw puzzle to have reduced thickness as well as largely reduced interval between contacts and therefore increased number of contacts in the circuit for emitting sounds.

### SUMMARY OF THE INVENTION

A primary object of the present invention is to provide a sound-emitting jigsaw puzzle in which the interval between contacts provided in its circuit for emitting sounds is largely reduced to result in largely increased number of contacts.

Another object of the present invention is to provide a sound-emitting jigsaw puzzle that has a base with effectively reduced internal space and a largely reduced overall weight and can therefore be produced at lower cost.

To achieve the above and other objects, the sound-emitting jigsaw puzzle of the present invention mainly includes a base on which a control unit is mounted to receive signals from a key unit and to emit a specific sound via a speaker according to signals from the key unit. The key unit includes a face panel, below which an upper and a lower circuit-contained film sandwiching an isolating film between them are provided. A plurality of equally spaced contacts are provided on the upper and the lower films to form a dot matrix when the two films are fully overlapped with each other. The isolating film is provided with a plurality of through holes via which contacts on the upper and the lower films can electrically contact with each other. The face panel is made of a high durometer foam rubber and has a lower surface provided with a plurality of keys corresponding to the contacts. When an area of the face panel is depressed, a key below that area is moved downward to cause corresponding contacts on the upper and the lower films to electrically contact with each other via the through hole on the isolating film and a specific sound is emitted at the same time. With the above-described key unit, the sound-emitting jigsaw puzzle may have a reduced overall thickness and the interval between contacts in its circuit may be largely reduced to increase the number of contacts, creating more funs in doing the jigsaw puzzle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective of a sound-emitting jigsaw puzzle according to the present invention;

FIG. 2 is an assembled perspective of the sound-emitting jigsaw puzzle of FIG. 1;

FIG. 3 is a block diagram showing the operation of a control unit included in the sound-emitting jigsaw puzzle of the present invention;

FIG. 4 is an enlarged fragmentary view of the sound-emitting jigsaw puzzle of the present invention;

FIG. 5 is a fragmentary sectional view of a key unit included in the sound-emitting jigsaw puzzle of the present invention in a released state; and

FIG. 6 is another fragmentary sectional view of the key unit included in the sound-emitting jigsaw puzzle of the present invention in a depressed state.

### DETAILED DESCRIPTION OF THE PREFERRED EMBODIMENTS

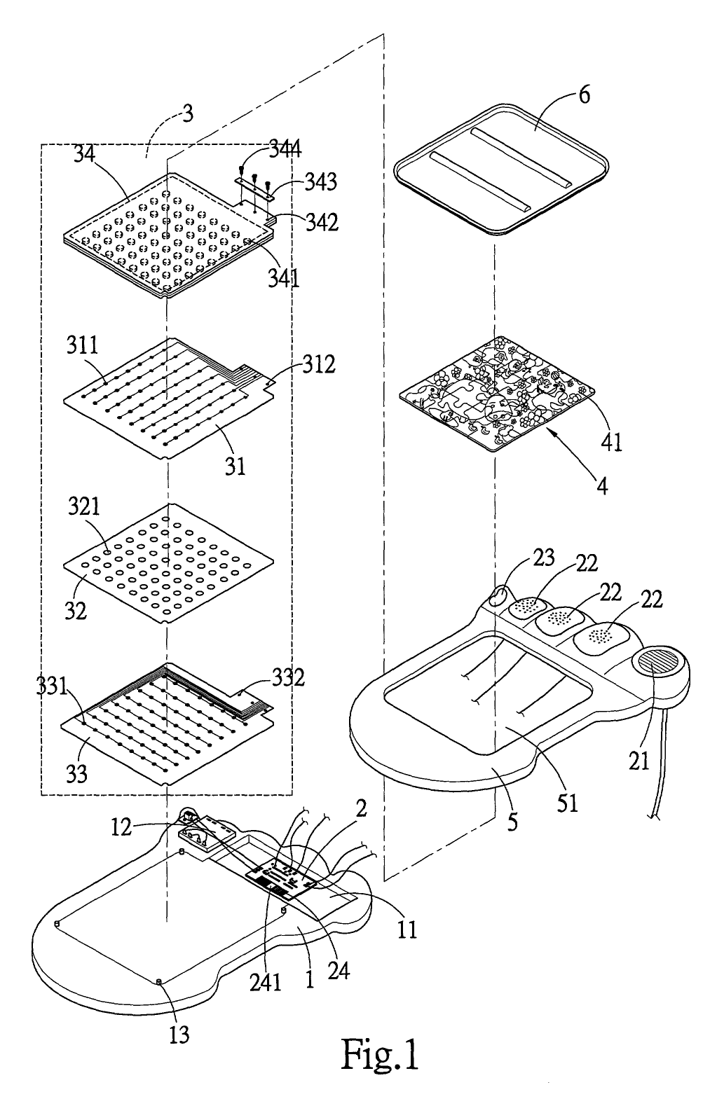

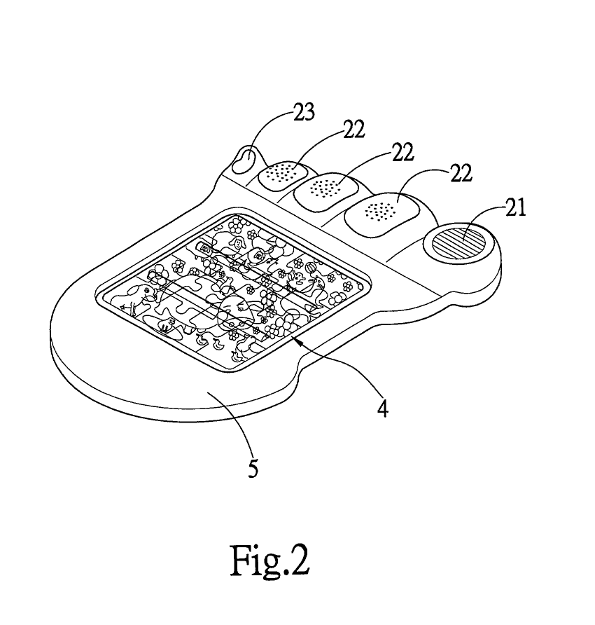

Please refer to FIGS. 1 and 2 that are exploded and assembled perspective views, respectively, of a sound-emitting jigsaw puzzle according to the present invention. As shown, the sound-emitting jigsaw puzzle mainly includes a base 1, a control unit 2, a key unit 3, a jigsaw puzzle unit 4, a top frame 5, and a top cover 6.

The base 1 is a board having a predetermined thickness. A recess 11 is formed on an upper surface of the base 1 close to one end thereof for the control unit 2 to mount therein. A battery compartment 12 in the form of a recess is formed on a lower surface of the base 1 adjacent to the recess 11 for receiving batteries (not shown) therein. An area on the upper surface of the base 1 adjacent to one side of the recess 11 is provided with four spaced locating studs 13 that form four corners of a square.

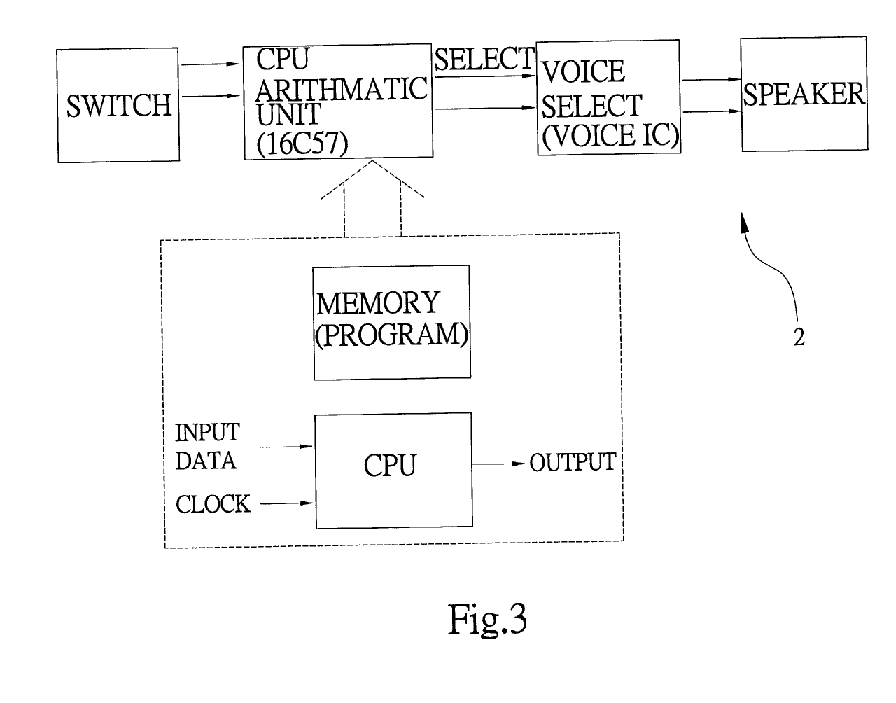

The control unit 2 is a circuit board provided with a PIC 16C57 IC to which some peripheral devices, such as a speaker 21, one or more light emitters 22, a switch 23, and a flat cable 24, are connected. FIG. 3 is a block diagram showing the operation of the control unit 2. The control unit 2 mainly includes a PIC 16C57 IC or other functionally similar integrated circuit. A control program package stored in a programmable memory is utilized to determine which contacts in a dot matrix of the key unit 3 are electrically connected under pressure. Data obtained from an operation based on the stored program are transmitted to a voice IC to determine which one of multiple types of sound pre-recorded in the voice IC is selected. The selected type of sound is then sent out via the speaker 21 while the one or more light emitters 22 emit lights. The key unit 3 includes an upper and a lower circuit-contained film 31, 33, an isolating film 32 sandwiched between the upper and the lower films 31, 33, and a face panel 34 spread over the upper circuit-contained film 31.

The upper and the lower circuit-contained films 31, 33 are provided with a plurality of longitudinal and transverse conductive lines, respectively, formed of silver gel and carbon powder. A plurality of contacts 311, 331 are equally spaced on the longitudinal and the transverse conductive lines, respectively, such that a dot matrix is formed when the upper and the lower circuit-contained films 31, 33 are fully overlapped with each other. All rear ends of the plural longitudinal and transverse conductive lines are guided to locate at the same side of the films 31, 33 to correspond to the flat cable 24 connected to and extended from the control unit 2. Fastening holes 312, 332 are provided on the films 31, 33, respectively, to correspond to fastening holes 241 provided in the recess 11 on the base 1.

The isolating film 32 isolates the upper and the lower circuit-contained films 31, 33 from each other. However, there are through holes 321 provided on the isolating film 32 corresponding to the contacts 311, 331 on the circuit-contained films 31, 33, so that the upper and the lower films 31, 33 are electrically connected at two corresponding contacts 311, 331 via a corresponding through hole 321 under pressure. The face panel 34 is spread over the upper circuit-contained film 31 and is made of a high durometer foam rubber material.

The face panel 34 has a flat and smooth upper surface onto which pieces 41 of the jigsaw puzzle unit 4 are laid, and a lower surface provided with downward protruded keys 341 corresponding to the contacts 311, 331. Fastening holes 342 are provided on the face panel 34 corresponding to the fastening holes 312, 332 on the upper and the lower films 31, 33. Screws 344 are sequentially screwed through a press plate 343 and the fastening holes 342, 312, 332 and 241 to bind the face panel 34, the upper circuit-contained film 31, the isolating film 32, and the lower circuit-contained film 33 into one key unit 3 electrically connected to the flat cable 24 of the control unit 2. At this point, the key unit 3 is seated on the upper surface of the base 1 with four dents provided at four corners of the key unit 3 engaged with the four locating studs 13 on the base 1.

The jigsaw puzzle unit 4 includes a plurality of irregularly shaped pieces 41.

The top frame 5 has contour and dimensions corresponding to that of the base 1 for tightly closing onto the base 1. A number of cavities are provided on a lower surface of the top frame 5 at one end thereof, so that the speaker 21, the one or more light emitters 22 and the switch 23 connected to the control unit 2 are separately received in the cavities. An area of the top frame 5 corresponding to the square defined by the four studs 13 is cut away to form a window 51. The window 51 has dimensions corresponding to that of the jigsaw puzzle unit 4.

The top cover 6 is a square member made of a clear material and has dimensions corresponding to that of the window 51 for removably fitted in the window 51.

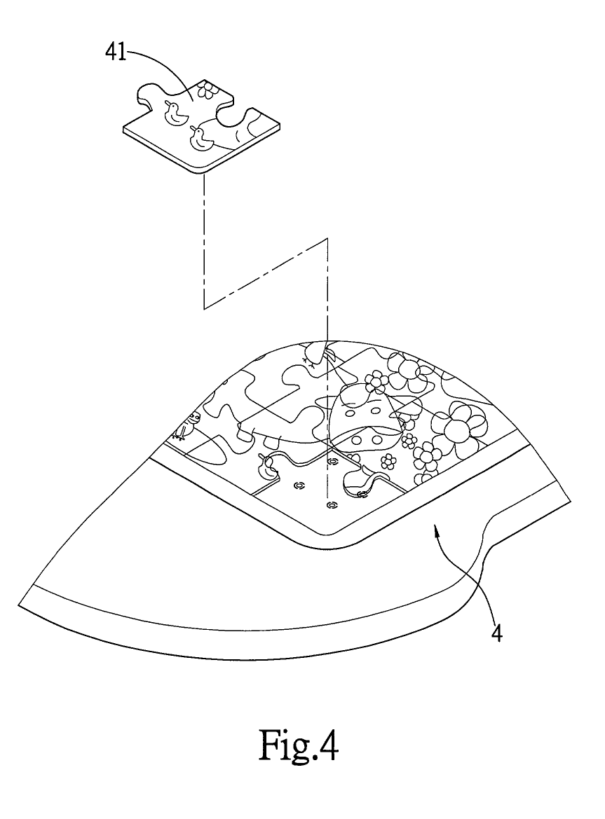

After all the above-described elements are assembled and the switch 23 is turned on, the face panel 34 will sound when it is subjected to a downward pressure. When doing a jigsaw puzzle on the face panel 34, each of the pieces 41 corresponds to a small group of keys 341 at the lower surface of the face panel 34, as shown in FIG. 4. More particularly, each of the pieces 41 is provided at a top surface with four designs, each of which corresponds to a key 341 and a specific sound previously recorded in the memory of the control unit 2. For example, when one piece 41 having a duck design is correctly put on the face panel 34 and pushes against a corresponding key 341, the key 341 is moved downward to cause electric contact of two corresponding contacts 311, 331 with each other via a corresponding through hole 321, causing the voice IC to emit the sound of duck that indicates the piece 41 is seated on the correct position.

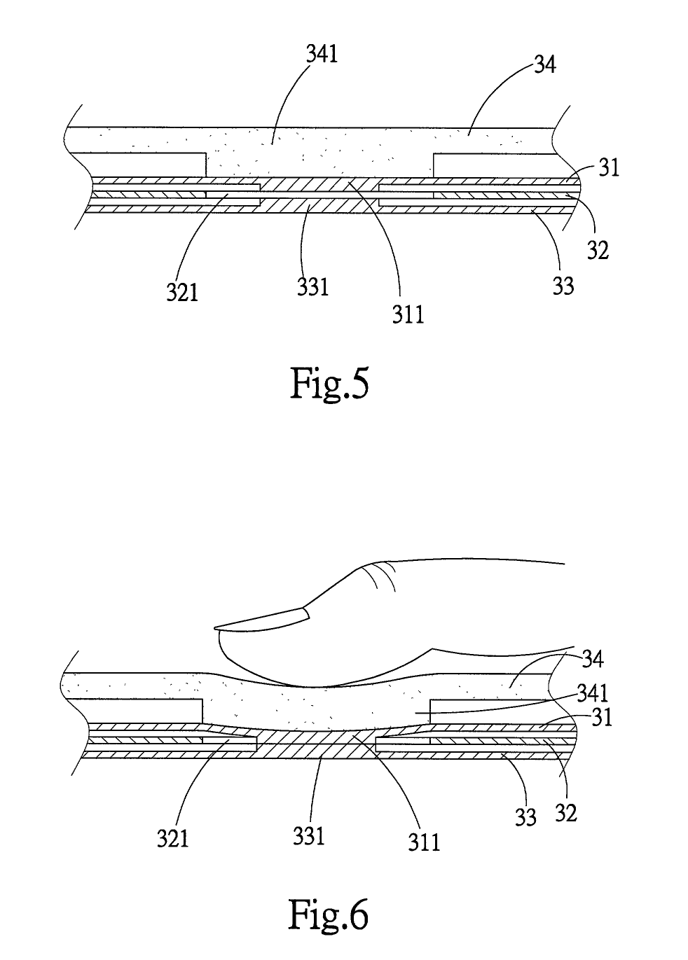

It can be clearly seen from FIGS. 5 and 6, a downward force applied on an area of the face panel 34 depresses the key 341 corresponding to the area to cause electric contact of two corresponding contacts 311, 331 with each other 341 via a corresponding through hole 321 on the isolating film 32.

With the above arrangements, the base 1 for the sound-emitting jigsaw puzzle may have largely reduced volume to enable reduced overall weight and manufacturing cost of the sound-emitting jigsaw puzzle. And, the numbers of contacts 311, 331 and puzzle pieces 41 may be freely increased or decreased to create more funs in doing jigsaw puzzle.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A sound-emitting jigsaw puzzle, comprising a base, a control unit mounted on said base at a predetermined location, a key unit seated on said base and electrically connected to said control unit for sending a signal to said control unit, a jigsaw puzzle unit consisting of a plurality of irregularly shaped pieces, and a speaker connected to said control unit for amplifying a specific sound selected and emitted by said control unit according to said signal from said key unit;
said key unit including a face panel, an upper and a lower circuit-contained film below said face panel, and an isolating film sandwiched between said upper and said lower circuit-contained films; said upper and said lower circuit-contained films being provided with a plurality of longitudinal and a plurality of transverse conductive lines, respectively, each of said conductive lines having a plurality of equally spaced contacts provided thereon, such that a dot matrix is formed when said upper and said lower circuit-contained films are fully overlapped with each other; said isolating film being provided with a plurality of through holes at locations corresponding to said contacts on said upper and said lower circuit-contained films to allow said upper film and said lower film to electrically connect to each other only at said through holes; and said face panel being made of a high durometer foam rubber, an upper surface of said face panel being flat and smooth for holding said pieces of said jigsaw puzzle unit thereon, and a lower surface of said face panel being provided with a plurality of downward protruded keys corresponding to said contacts on said upper and said lower circuit-contained films;
whereby when a downward force is applied on an area of said face panel to depress one of said keys corresponding to the area, said contacts on said upper and said lower circuit-contained films corresponding to said depressed key are brought to electrically contact with each other via one of said through holes on said isolating film corresponding to said depressed key, causing said jigsaw puzzle to emit a sound.

2. A sound-emitting jigsaw puzzle as claimed in claim 1, wherein each of said pieces forming said jigsaw puzzle unit has top designs corresponding to a small group of said keys below said face panel.

3. A sound-emitting jigsaw puzzle as claimed in claim 2, wherein each of said pieces forming said jigsaw puzzle unit has four top designs, each of which corresponding to one of said keys below said face panel.
